(19) United States
(12) Patent Application Publication
(10) Pub. No.: US 2020/0247027 A1
(43) Pub. Date: Aug. 6, 2020

(54) METHOD FOR MANUFACTURING A HEAT INSULATED PVB FILM AND HEAT INSULATED BLAST-RESISTANT GLASS

(71) Applicant: SUBANYO INC., Taoyuan City (TW)

(72) Inventors: Ruei-Hong Hsu, Taoyuan City (TW); Jui-Cheng Hsu, Taoyuan City (TW)

(21) Appl. No.: 16/268,910

(22) Filed: Feb. 6, 2019

(51) Int. Cl. B29C 48/00; B29C 48/88; C08L 29/14; C08K 3/01; B32B 17/10

(52) U.S. Cl. CPC B29C 48/0018; B29C 48/0022; B29C 48/914; C08L 29/14; B29K 2029/14; B32B 17/10761; B32B 17/10036; B32B 17/10816; B32B 17/10972; C08K 3/01

(57) ABSTRACT

The disclosure provides a method for manufacturing a heat insulated PVB film, in which insulated nanoparticles with a particle diameter of 1-800 nm are added in the manufacturing process of PVB film to allow production of a PVB film with high insulation and transmittance. The disclosure also provides a method for manufacturing heat insulated blast-resistant glass, in which two panes of glass are laminated and bound by the PVB film to obtain blast-resistant glass with high insulation and high transmittance. The method for manufacturing heat insulated blast-resistant glass needs not applying an additional insulation coating or insulation film on conventional glass products and therefore allows manufacturing process to be simplified and manufacturing costs to be reduced.

### BACKGROUND OF THE INVENTION

### 1. Field of the Invention

The present invention relates to a method for manufacturing a heat insulated PVB film and a method for manufacturing a blast-resistant glass comprising the heat insulated PVB film.

### 2. The Prior Arts

Glass itself exhibits characteristics such as high transmittance, but is easy to be broken. In order to prevent the fragments of glass in the event of a collision from causing secondary injury to personnel nearby, prior art has provided a blast-resistant glass which includes two panes of glass and a PVB (Polyvinyl Butyral Resin) film between the two panes of glass. As the glass is firmly adhering onto the PVB film, in the event of a collision, the fragments of the glass are hold and adhered by the PVB film, rather than flying apart, thereby reducing chances of secondary injury to personnel near the collision.

Besides, glass is widely used in automobiles or architectural buildings due to its high transmittance. Yet when irradiated by sun, conventional glass does not block infrared rays from sunlight, causing the temperature inside automobiles and buildings to rise. As a result, prior art provides a heat insulated film which is to be adhered on the surface of the glass in an additional procedure after manufacture of the glass, to ensure high transmittance or at least partial transmittance while blocking infrared rays at the same time. Furthermore, prior art also provides a heat insulated coating which is to be sprayed or painted on the glass or on metals in an additional procedure after manufacture of the glass, to reflect the infrared rays in sunlight, thereby preventing the temperature inside automobiles and buildings to rise to an extent too high.

### SUMMARY OF THE INVENTION

Yet, either applying a heat insulated film or a heat insulated coating requires an additional processing procedure on conventional glass products, which is inconvenient and increases costs for manufacture.

In order to solve the above-mentioned problems, the present invention is developed to provide a method for manufacturing a PVB film with heat insulated effect. The PVB film manufactured thereby is introduced between two layers of glass for adhesion, so as to directly obtain a blast-resistant glass offering heat insulation and high transmittance. The blast-resistant glass of the present invention can be generally used in architectural glass, automotive glass, and a variety of applications that require both daylighting and heat insulation.

An embodiment of the present invention provides a method for manufacturing a heat insulated PVB film, comprises: a drying step drying PVB resin; a mixing step mixing 80˜99.99 w.t. % of the PVB resin with 0.01˜20 w.t. % of heat insulated nanoparticles uniformly at a temperature of 60˜80° C. to obtain a PVB resin mixture; an extrusion molding step extruding the PVB resin mixture in a melt state at 270˜290° C. and then transferring the same to a cooling roller to be quenched and roller pressed to become a PVB film; a calendering step stretching the PVB film; a rolling step rolling the stretched PVB film into a parent roll; and a cutting step cutting the PVB film of the parent roll into product size.

Preferably, in the mixing step, adding an addictive agent into the PVB resin before mixing the PVB resin with the heat insulated nanoparticles; the addictive agent is at least one auxiliary agent selected from the group consisting of plasticizer, anti-UV agent, light stabilizer, weather-resistant modifier, heat-resistant modifier, hydrolysis-resistant modifier, slip modifier and crystallization modifier.

Preferably, the nanoparticles are at least one type of nanoparticles selected from the group consisting of indium tin oxide, tungsten oxide, antimony tin oxide, lanthanum hexaboride, carbon black, lithium fluoride tin oxide and tungsten bronze oxide.

Preferably, tungsten oxide has a general formula W_{y}O_{z}, and tungsten bronze oxide has a general formula MₓW_{y}O_{z}; wherein, M is at least one element selected from the group consisting of H, He, alkali metals, alkaline earth metals, rare earth elements, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I; and wherein, 0.001≤x/y≤1, and 2.2≤z/y≤3.0.

Preferably, the heat insulated nanoparticles have a particle diameter of 1˜800 nm.

Preferably, the heat insulated nanoparticles further include dispersed nanoparticles which are at least one type of nanoparticles selected from the group consisting of silicon oxide, barium sulfate, calcium carbonate, zirconium oxide, granular aluminium oxide, flaky aluminium oxide, flaky mica and platy diatomaceous earth.

Preferably, the dispersed nanoparticles have a particle diameter of 1˜800 nm, and the particle diameter of the dispersed nanoparticles is smaller than the heat insulated nanoparticles.

Preferably, the method for manufacturing a heat insulated PVB film further comprises: a corona treating step treating both surfaces of the PVB film with corona by a high frequency high voltage power supply after the calendering step.

Preferably, in the calendering step, a vertical stretching is performed at a temperature of 80˜90° C. and a horizontal stretching is performed at a temperature of 80˜90° C.

The method for manufacturing a heat insulated PVB film according to the present invention not only provides a PVB film with high transmittance and high adhesion, but also reduces infrared rays of sunlight from passing through the PVB film via the nanoparticles therein which block infrared rays, thereby preventing the temperature inside automobiles and buildings to rise due to infrared rays.

Another embodiment of the present invention provides a method for manufacturing heat insulated blast-resistant glass, comprises: an adhering step placing a heat insulated PVB film between two panes of glass of predetermined dimension and adhering the heat insulated PVB film tightly with the glass to obtain a semi-product; a prepressing step placing the semi-product into a room-temperature vacuum environment for first de-airing, and then heating the semi-product for continuous de-airing, and then pressing the same; and a compression molding step heating and pressing the semi-product undergone the prepressing step for a determined time and then cooling the same to obtain the heat insulated blast-resistant glass; wherein, the heat insulated PVB film is obtained by the method for manufacturing a heat insulated PVB film according to the present invention.

Preferably, the method for manufacturing heat insulated blast-resistant glass according to the present invention further comprises: a heat bending step bending the glass into an arc shape by hot pressing before the adhering step.

Preferably, the heat bending step is performed at a temperature of 680˜710° C.

Preferably, the adhering step is performed at a temperature of 18˜25° C. in a 18˜30% humidity environment.

Preferably, in the prepressing step, the first de-airing is performed at a temperature of 18˜30° C. in a −0.08˜−0.10 MPa vacuum environment.

By the method for manufacturing heat insulated blast-resistant glass according to the present invention, the glass is tightly adhered on the PVB film due to the toughness and adherence of the PVB film. Thereby, in the event where the glass is impacted and broke into pieces, the fragments thereof will be hold by the PVB film rather than flying apart to everywhere. Besides, the PVB film further includes nanoparticles which can block infrared rays and are a substitution for the heat insulated film or the heat insulated coating which requires additional processing procedures. Thus, the method for manufacturing heat insulated blast-resistant glass according to the present invention allows manufacturing process to be simplified and manufacturing costs to be reduced.

### BRIEF DESCRIPTION OF THE DRAWINGS

The present invention will be apparent to those skilled in the art by reading the following detailed description of a preferred embodiment thereof, with reference to the attached drawings, in which:

FIG. 1 illustrates a method for manufacturing a heat insulated PVB film according to an embodiment of the present invention;

FIG. 2 illustrates a method for manufacturing heat insulated blast-resistant glass according to another embodiment of the present invention; and

FIG. 3 is a cross-sectional view of the heat insulated blast-resistant glass according to said another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

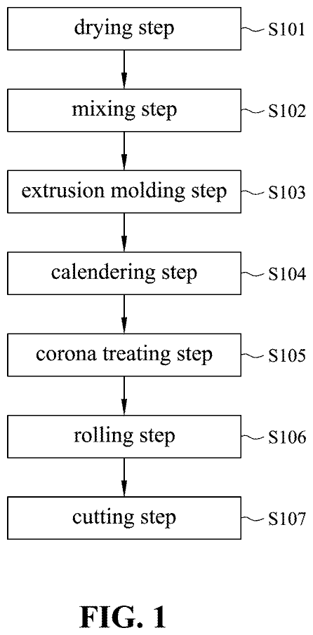

Referring to FIG. 1, an embodiment of the present invention provides a method for manufacturing a heat insulated PVB film, the method comprises a drying step S101, a mixing step S102, an extrusion molding step S103, a calendering step S104, a corona treating step S105, a rolling step S106, and a cutting step S107.

First, the drying step S101 is performed to dry PVB resin. If there remains excess water vapor in the PVB resin, the PVB film manufactured therefrom will result in foggy water patterns which affect its transmittance. A way of drying, for example, may be putting the PVB resin into a vacuum dryer for drying. The vacuity of the vacuum dryer may be 100˜110 kPa with a drying time of 6˜10 hr, and the dried PVB resin is preferable to have a moisture content lower than 0.3 w.t. %.

Next, the mixing step S102 is performed. The dried PVB resin is put into a mixer, the temperature is raised to 60˜80° C. for the PVB resin to become softer and melt, and then heat insulated nanoparticles are put into the mixer to be stirred uniformly to obtain a PVB resin mixture. The PVB resin mixture may contain 80˜99.99 w.t. % of the PVB resin and 0.01˜20 w.t. % of the heat insulated nanoparticles in weight ratio. The mixing step S102 may be performed by using a single-screw or a double-screw extruder to mix and blend the PVB resin and the heat insulated nanoparticles, but mechanisms of mixing is not limited hereto. Wherein, the PVB resin and the heat insulated nanoparticles are crushed, plasticized, sheared, and uniformly distributed by the high shearing force output by the screw extruder, such that the two substances become a homogenous mixture.

Wherein, the nanoparticles are at least one type of nanoparticles selected from the group consisting of indium tin oxide (ITO), tungsten oxide (W_{y}O_{z}), antimony tin oxide (ATO), lanthanum hexaboride (LaB₆), carbon black, lithium fluoride tin oxide (LiFTO) and tungsten bronze oxide (MₓW_{y}O_{z}).

Besides, tungsten oxide has a general formula W_{y}O_{z}, and tungsten bronze oxide has a general formula MₓW_{y}O_{z}; wherein, M is at least one element selected from the group consisting of H, He, alkali metals, alkaline earth metals, rare earth elements, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I; and wherein, 0.001≤x/y≤1, and 2.2≤z/y≤3.0.

When the materials mentioned-above are reduced to nanoscale, lights with a particular wavelength, in particular infrared rays with a wavelength of 780˜1000 nm, may be blocked by, for example, surface plasmon Resonance (SPR), thereby realizing a heat insulation effect. In addition, in order to maintain the transmittance of the PVB film, it is preferable that the heat insulated nanoparticles have a particle diameter of 1˜800 nm. This is because in the case where the particle diameter of the nanoparticles is below 800 nm, the nanoparticles will allows visible lights to pass through, rather than sheltering all the lights by a scattering process. In a situation where heat insulation and high transmittance are both required, the heat insulated nanoparticles are more preferable to have a particle diameter below 200 nm, and optimal below 100 nm. This is because in the case where the particle diameter is below 200 nm, chances of geometric scattering and Mie scattering are decreased, thereby lights at visible light region with a wavelength of 400˜780 nm are less likely to be scattered. When the nanoparticles have a particle diameter below 200 nm, chances of Rayleigh scattering, in addition to the afore-mentioned geometric scattering and Mie scattering, is also reduced. The intensity of lights scattered by Rayleigh scattering decreases as the particle diameter of the nanoparticles decreases. A decrease of scattering implies that more lights at the visible light region are allowed to pass through the PVB film, making the PVB film high in transmittance. Furthermore, from a perspective of production, it is easier for the manufacturer to produce heat insulated nanoparticles above 1 nm.

In order to uniformly distribute the heat insulated nanoparticles in the PVB film, such that the PVB film overall offers uniform heat insulation and high transmittance, the heat insulated nanoparticles may further include dispersed nanoparticles as dispersant. The heat insulated nanoparticles are at least one type of nanoparticles selected from the group consisting of silicon oxide (SiO₂), barium sulfate (BaSO₄), calcium carbonate (CaCO₃), zirconium oxide (ZrO₂), granular aluminium oxide (Al₂O₃), flaky aluminium oxide, flaky mica and platy diatomaceous earth. Similarly, in order to prevent the dispersed nanoparticles from scattering visible lights and reducing transmittance of the PVB film, the particle diameter of the dispersed nanoparticles may be 1˜800 nm, preferably smaller than the heat insulated nanoparticles.

In the mixing step S102, besides adding the heat insulated nanoparticles to improve the blocking of infrared rays, plasticizers may also be added before the addition of the heat insulated nanoparticles to make treatments on the PVB resin easier and produce PVB films with high transparency. The amount of the plasticizer is not limited but can be added as needed, as long as the PVB film does not become foggy. Before the addition of the heat insulated nanoparticles, other additive agent may be added into the PVB resin if necessary, to improve physical and chemical properties of the PVB film. The addictive agent is at least one auxiliary agent selected from the group consisting of plasticizer, anti-UV agent, light stabilizer, weather-resistant modifier, heat-resistant modifier, hydrolysis-resistant modifier, slip modifier and crystallization modifier.

After the PVB resin mixture is obtained, the extrusion molding step S103 is performed. In the extrusion molding step S103, the PVB resin mixture is extruded in a melt state and then transferred to a cooling roller to be quenched and roller pressed to become a PVB film. In order to provide the PVB resin mixture with adequate fluidity so that it can be easily roller pressed into a film, the extruding temperature is preferable at 270˜290° C. The PVB melt can be rapidly cooled from a high temperature to a glass transition temperature (Tg) by the cooling roller, so that degree of crystallization in the PVB film can be controlled. If the degree of crystallization in the PVB film is low, the PVB film offers higher transmittance and higher flexibility.

The roller pressed PVB film then undergoes the calendering step S104 to be stretched. The stretched PVB film has a higher mechanical strength in the stretching directions which may include a horizontal stretching and a vertical stretching. The horizontal and the vertical stretching of the PVB film can be performed by a bi-directional stretching machine, and the temperature for stretching is at 80˜90° C.

The stretched PVB film may selectively undergo the corona treating step S105. In the corona treating step S105, both surfaces of the PVB film are treated with corona, so that the surfaces of the PVB film are modified. Nevertheless, as needed, the next step may be directly performed without the corona treatment.

Next, the rolling step S106 is performed. In the rolling step S106, the stretched PVB film is rolled and collected into a parent roll. An aging treatment may be selectively performed on the parent roll as needed, and the aging treatment time can be 24˜36 hr. After the aging treatment is completed, the cutting step S107 is performed to cut the PVB film of the parent roll into product size.

By the embodiment illustrated above, the present invention allows manufacture of a high-transmittance PVB film with heat insulated nanoparticles. The PVB film is to be adhered to glass to prevent the fragments of the glass from flying apart when the glass is impacted and broken. Besides, by the above-mentioned heat insulated nanoparticles, infrared rays with a wavelength of 780˜1000 nm are effectively blocked and visible lights with a wavelength of 400˜780 nm are allowed to pass through. As a result, the PVB film realizes a heat insulation effect while maintaining its transmittance by the heat insulated nanoparticles.

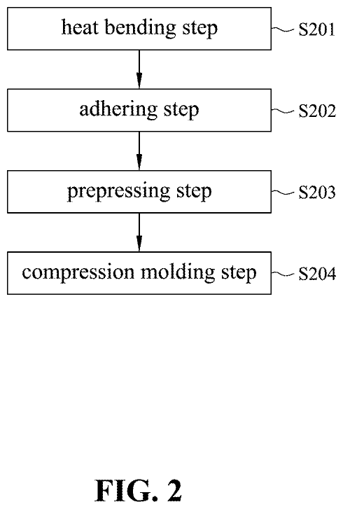

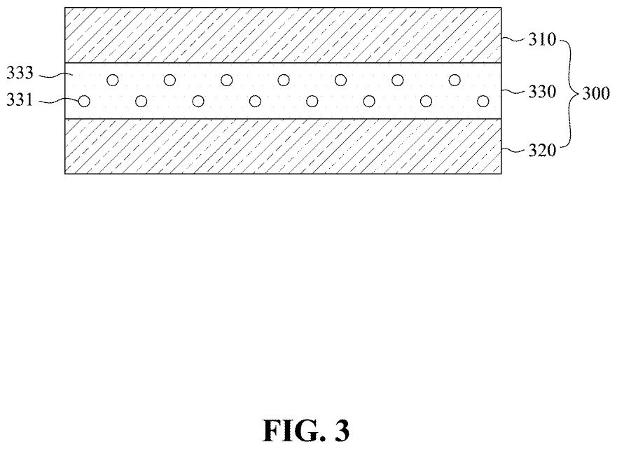

Referring to FIG. 2, which illustrates a method for manufacturing heat insulated blast-resistant glass according to another embodiment of the present invention. The method comprises a heat bending step S201, an adhering step S202, a prepressing step S203 and a compression molding step S204.

Wherein, the heat bending step S201 is to bend the flat glass by hot pressing to make the glass become an arc shape. The temperature for heating can be at 680˜710° C. as needed. In cases where the glass is applied as automotive windshields which require an arc shape, the flat glass may undergo the heat bending step S201; in cases where the glass is applied by its flat form as shown in FIG. 3, for example as flat glass curtain of an architectural building, the adhering step S202 is directly performed and the heat bending step S201 may be skipped.

Next, the adhering step S202 is performed. In the adhering step S202, the heat insulated PVB film manufactured by the above-mentioned embodiment is placed between two panes of glass of predetermined dimension and the heat insulated PVB film is adhered tightly with the glass to obtain a semi-product. The procedure of adhering is preferable performed at a temperature of 18˜25° C. in a 18˜30% humidity environment. If the temperature and humidity is too high, the PVB film layer contains too much moisture, decreasing the adhesion between the glass and the PVB film; the glass may become detached and raises safety issues. In contrary, when the PVB film contains too less moisture, the adhesion effect will also be affected.

Next, the prepressing step S203 is performed. In the prepressing step S203, the semi-product is placed into a room-temperature vacuum environment for first de-airing, heated for continuous de-airing, and then pre-pressed. In order to ensure the de-airing effect, the first de-airing may be performed at a temperature of 18˜30° C. in an −0.08˜−0.10 MPa vacuum environment. If the degree of vacuum is not sufficient, the air between the PVB film and the glass cannot be drawn out. If the degree of vacuum is too high, the PVB film layer may be easily pulled out from the glass, causing the glass to break. The semi-product is then heated to a temperature of 85˜115° C. for continuous de-airing and pre-pressing. If the temperature for continuous de-airing is too low, the PVB film is not softened to an extent to bind the glass together. If the temperature is too high, the PVB film will result in premature edge sealing which prevents the remaining air from being drawn out.

Then, the compression molding step S204 is performed. In the compression molding step S204, the semi-product undergone the prepressing step S203 is heated and pressed for a determined time and then cooled to obtain the heat insulated blast-resistant glass 300, of which a structure is shown in FIG. 3. As shown in FIG. 3, in the heat insulated blast-resistant glass 300, the PVB film 330 used to bind the glass 310 and 320 is mainly composed by PVB resin and includes heat insulated nanoparticles 331 and dispersed nanoparticles 333 for uniform dispersion. The PVB film 330 offers excellent toughness allowing the impact force received by the glass 310 and 320 to be absorbed, and strong binding allowing a tight adhesion with the glass 310 and 320. Even in the event when the glass 310 and 320 is hit by massive impact, the fragments will be hold with the PVB film 330 and are not easily scattered around; thereby, chances of secondary injury to personnel are decreased and safety is greatly improved. The PVB film 330 also offers high transmittance, such that the transmittance of the heat insulated blast-resistant glass 300 in overall is not decreased when the glass 310 and 320 are adhered. Furthermore, in the PVB film 330, the heat insulated nanoparticles 331 with a particle diameter of 1˜800 nm can effectively block infrared rays with a wavelength of 780˜1000 nm from passing through, decreasing the chances that visual lights with a wavelength of 400˜780 nm being scattered. As a result, the heat insulated nanoparticles can effectively block infrared rays to realize a heat insulation effect without reducing the transmittance of the PVB film 330 in overall.

By the method for manufacturing heat insulated blast-resistant glass according to the present invention, the glass is tightly adhered to the PVB film due to the toughness and adhesion of the PVB film. Thereby, when the glass is hit and broken into fragments, the fragments will be hold by the PVB film rather than flying apart to everywhere. Furthermore, the PVB film further includes nanoparticles which can block infrared rays, as a substitution for the heat insulated film or the heat insulated coating which require additional processing procedures. Thus, the method for manufacturing heat insulated blast-resistant glass according to the present invention allows the manufacturing process to be simplified and manufacturing costs to be reduced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for manufacturing a heat insulated PVB film, comprising:
a drying step drying PVB resin;
a mixing step mixing 80˜99.99 w.t. % of the PVB resin with 0.01˜20 w.t. % of heat insulated nanoparticles uniformly at a temperature of 60˜80° C. to obtain a PVB resin mixture;
an extrusion molding step extruding the PVB resin mixture in a melt state at 270˜290° C. and then transferring the same to a cooling roller to be quenched and roller pressed to become a PVB film;
a calendering step stretching the PVB film;
a rolling step rolling the stretched PVB film into a parent roll; and
a cutting step cutting the PVB film of the parent roll into product size.

2. The method according to claim 1, wherein in the mixing step, adding an addictive agent into the PVB resin before mixing the PVB resin with the heat insulated nanoparticles; the addictive agent is at least one auxiliary agent selected from the group consisting of plasticizer, anti-UV agent, light stabilizer, weather-resistant modifier, heat-resistant modifier, hydrolysis-resistant modifier, slip modifier and crystallization modifier.

3. The method according to claim 1, wherein the nanoparticles are at least one type of nanoparticles selected from the group consisting of indium tin oxide, tungsten oxide, antimony tin oxide, lanthanum hexaboride, carbon black, lithium fluoride tin oxide and tungsten bronze oxide.

4. The method according to claim 1, wherein tungsten oxide has a general formula W_{y}O_{z}, and tungsten bronze oxide has a general formula MₓW_{y}O_{z}; wherein, M is at least one element selected from the group consisting of H, He, alkali metals, alkaline earth metals, rare earth elements, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I; and wherein, 0.001≤x/y≤1, and 2.2≤z/y≤3.0.

5. The method according to claim 1, wherein the heat insulated nanoparticles have a particle diameter of 1˜800 nm.

6. The method according to claim 5, wherein the heat insulated nanoparticles further include dispersed nanoparticles which are at least one type of nanoparticles selected from the group consisting of silicon oxide, barium sulfate, calcium carbonate, zirconium oxide, granular aluminium oxide, flaky aluminium oxide, flaky mica and platy diatomaceous earth.

7. The method according to claim 6, wherein the dispersed nanoparticles have a particle diameter of 1˜800 nm and the particle diameter of the dispersed nanoparticles is smaller than the heat insulated nanoparticles.

8. The method according to claim 1 further comprising:
a corona treating step treating both surfaces of the PVB film with corona by a high frequency high voltage power supply after the calendering step.

9. The method according to claim 1, wherein in the calendering step, a vertical stretching is performed at a temperature of 80˜90° C. and a horizontal stretching is performed at a temperature of 80˜90° C.

10. A method for manufacturing heat insulated blast-resistant glass, comprising:
an adhering step placing a heat insulated PVB film between two panes of glass of predetermined dimension and adhering the heat insulated PVB film tightly with the glass to obtain a semi-product;
a prepressing step placing the semi-product into a room-temperature vacuum environment for first de-airing, and then heating the semi-product for continuous de-airing, and then pressing the same; and
a compression molding step heating and pressing the semi-product undergone the prepressing step for a determined time and then cooling the same to obtain the heat insulated blast-resistant glass;
wherein, the heat insulated PVB film is obtained by the method according to claim 1.

11. The method according to claim 10 further comprising:
a heat bending step bending the glass into an arc shape by hot pressing before the adhering step.

12. The method according to claim 11, wherein the heat bending step is performed at a temperature of 680˜710° C.

13. The method according to claim 10, wherein the adhering step is performed at a temperature of 18˜25° C. in a 18˜30% humidity environment.

14. The method according to claim 10, wherein in the prepressing step, the first de-airing is performed at a temperature of 18˜30° C. in a −0.08˜−0.10 MPa vacuum environment.
